(19) United States
(12) Patent Application Publication
(10) Pub. No.: US 2009/0237196 A1
(43) Pub. Date: Sep. 24, 2009

(54) Method for manufacturing transformer, and transformer

(76) Inventors: Osamu Watanabe, Saitama (JP); Junji Kondo, Saitama (JP)

Correspondence Address: DAY PITNEY LLP, 7 TIMES SQUARE, NEW YORK, NY, 10036-7311, US

(21) Appl. No.: 11/989,913

(22) PCT Filed: Aug. 1, 2006
(86) PCT No.: PCT/JP2006/315234

§ 371 Date: Nov. 3, 2008

(30) Foreign Application Priority Data
Aug. 1, 2005 (JP) 2005-222432

(51) Int. Cl. H01F 27/26; H01F 41/00; H01F 27/24

(52) U.S. Cl. 336/210; 29/606; 336/212

(57) ABSTRACT

A core is configured with two O-type cores and an I-type core which is separate from the O-type cores. In a transformer comprising a core of the type, by incorporating a first O-type core, a bobbinless coil block and a second O-type core to be stacked on a terminal block sequentially, excellent assemblability is achieved. Further, the first O-type core is incorporated from one side to the terminal block, and the bobbinless coil block and the second O-type core are incorporated by stacking up from the other side. Further, the first O-type core, the bobbinless coil block, the second O-type core and the terminal block are assembled by being stacked up.

### TECHNICAL FIELD

This invention relates to a transformer which is used for a consumer electronics equipment and a manufacturing method for the transformer.

### BACKGROUND OF THE INVENTION

A transformer is configured in a way such that a core is incorporated into a coil bobbin which is looped around with a coil wire. For the core, conventionally thin laminated silicon steel plates have been used. However, since there is a problem of beat noise in using the core, a ferrite core is used in substitution for the silicon steel plates.

For the core of the transformer, generally a core such as an EI-type core or an EE-type core is used. In such the core, outer legs and an inner leg are formed integrally, and a coil bobbin wound around with a coil is configured to be attached to the inner leg. In order to pursuit of efficiency in capacity, space, etc for the transformer comprising a ferrite core, it is important to secure a larger cross section of the core and accommodate the core in the smallest space. However, the transformer having the core integrally formed with an inner leg cannot be efficiently realized to be a large capacity, compact, low profile or space-saving transformer, etc.

There is disclosed in Japanese Patent Application Provisional Publication 2005-72261 a transformer which makes it possible to have a larger cross section of a core inner leg by dividing a core cross section into an upper section and a lower section and combining two O-type cores and an I-type core. According to the configuration of the transformer, since a cross section of side legs is divided into an upper section above the I-type core and a lower section beneath the I-type core, a ratio of dimensions of each core may be changed appropriately to realize a low profile transformer, etc.

The low profile transformer is configured with a coil bobbin in which the coil is wound around a circumference of a winding-drum section, an inner leg inserted into and penetrating an opening of the winding-drum section, an upper O-type core and a lower O-type which have openings in the center and are located so as to surround the coil bobbin and bind together vertically each of edges of the inner leg protruding from both sides of the winding-drum section. Terminal blocks of shapes of flanges are formed in both sides of the bottom of the coil bobbin. Terminals are implanted in the blocks.

### DISCLOSURE OF THE INVENTION

The above mentioned transformer comprises a coil bobbin with a terminal block. The transformer is assembled in a way that after winding a coil around a circumference of the coil bobbin, a lower core is placed on the terminal block from above, an inner leg is inserted into the coil bobbin from side, and an upper core is placed from above.

Thus, there has been a problem that assemblability of the transformer is not so good, since the transformer is not configured to be assembled as stacking up components sequentially in the same direction.

In addition to a process of winding a coil around the coil bobbin, a process to insert an inner leg into the coil bobbin from side is needed, which makes the assembly process more complicated.

In view of the foregoing various issues, the present invention has been made. An object thereof is to provide a manufacturing method of a transformer which can attain good assemblability of a transformer comprising two O-type cores and an I-type core which is an inner leg, by dividing a core cross section into an upper section and a lower section and by configuring the transformer such that components can be stacked in the same direction or in the upward and downward directions in the assembly process, and to provide a transformer which is manufactured using the method.

A manufacturing method of a transformer according to an embodiment of the present invention comprises the step of: incorporating a first O-type core to be stacked on an upper surface of a terminal block having a shape of a frame which is implanted with terminals in bottom surfaces of terminal sections at both ends of the terminal block; incorporating a coil block comprising an I-type core and a coil wound around the I-type core to be stacked on the first O-type core; and incorporating a second O-type core having a shape of a frame to be stacked on the coil block.

According to the method, since the transformer is assembled by stacking up members in a direction, efficient assemblability is attained, and the method is suitable for mass production.

A transformer according to an embodiment of the present invention comprises: a terminal block having a shape of a frame which is implanted with terminals in a bottom surfaces of terminal sections at both ends of the terminal block; a first O-type core of a shape of a frame which is laid on an upper surface of the terminal block; a coil block including an I-type core of which both ends are placed on the first O-type core; a second O-type core having a shape of a frame which is placed on the I-type core of the coil block.

According to the configuration, since the transformer is assembled by stacking up members in a direction, efficient assemblability is attained, and the method is suitable for mass production.

In addition, when the terminal block is made to be a shape of a frame, the terminal block and a coil block may not interfere with each other, and a low profile transformer is easily realized.

Optionally, I-type core positioning sections having a shape of a plate are formed to stand upward at central parts of outer surfaces of both ends of terminal sections of the terminal block; core attaching sections having a shape of a plate are formed upward on inner surfaces of the terminal sections, an I-type core is placed between the I-type core positioning sections; and the first O-type core and the second O-type core are attached on outsides of the core attaching sections.

According to the configuration, an I-type core of the coil block is positioned by the I-type core positioning sections, which can prevent looseness and rattling of the I-type core in a core's axial direction. In addition, the second O-type core is incorporated while being positioned by the core attaching sections.

Optionally, there are provided pawl sections which are configured to engage with the second O-type core at outside of upper ends of the core attaching sections.

Alternatively or additionally, upper ends of the core attaching sections and the second O-type core are fixed with each other with adhesive.

With the configuration, incorporated components are hard to be loosened.

A production method of a transformer according to some of the embodiments of the present invention comprises incorporating an first O-type core having a shape of a frame on a terminal block having a window to be formed in a shape of a frame, being implanted with terminals in bottom surfaces of terminal sections at both ends of the terminal block, and having recessed portions formed in bottoms of connecting sections which connect both ends of the terminal block so that the first O-type core is stacked on the terminal block from below, incorporating a coil block comprising an I-type core and a coil wound around the core into the window of the terminal block from above, incorporating a second O-type core having a shape of a frame to be stacked on an upper surface of the coil block from above.

According to the method, since the transformer is assembled as stacking each members from upward and downward directions, efficient assemblability is attained, and the method is suitable for mass production

A transformer according to an embodiment of the present invention comprises a terminal block having a shape of a frame which is implanted with terminals in bottom surfaces of terminal sections at both ends of the terminal block, a first O-type core which is incorporated into recessed portions formed in a bottom of the terminal block, a coil block which has an I-type core and a coil wound around the core and is incorporated in a window of the terminal block from above, and a second O-type core having a shape of a frame which is placed on both ends of the I-type core of the coil block.

According to the method, since the transformer is assembled as stacking members in the upward and downward directions, efficient assemblability is attained, and the method is suitable for mass production.

Optionally, a window of a shape substantially the same as an outer shape of the coil block is formed in the terminal block, second O-type core attaching sections are formed to stand upward at both sides of the terminal sections of the window, in the second O-type core attaching sections, substantially U-shaped protrusions which receive ends of the I-type core are formed and core attaching pieces which extend outward in a shape of a flange at inner ends of the protrusions and of which upper ends protrude upward from upper ends of the protrusions are formed, and the second O-type core is located between the upper ends of the core attaching pieces and the upper ends of the protrusions.

According to the configuration, since a coil block is placed in a window of the terminal block, height dimension can be reduced to realize a low profile transformer. In addition, since the second O-type core attaching sections have substantially the same forms as an outer form of the coil block, the coil block located in the core can be positioned. Further, since a step is formed in the second O-type core attaching portion, and the second O-type core can be mounted in the step, thickness of the second O-type core can be covered by the step portion, height dimension can be reduced to realize a low profile transformer.

Optionally, there are provided pawl sections which are configured to engage with the second O-type core at outside of upper ends of the core attaching pieces.

Alternatively or additionally, upper ends of the core attaching pieces and the second O-type core are fixed with each other with adhesive.

In an aspect of one of some embodiments of the present invention, the coil block is a bobbinless coil block and comprises: a thin insulating material laid around a circumference of the I-type core; margin tapes laid on both ends of the insulating material; and a coil wound between the margin tapes.

According to the configuration, since the coil block is bobbinless, a bobbin is not necessary and a process to insert the I-type core into the bobbin is not also necessary. Further, since no bobbin is on a circumference of the I-type core, and a coil is placed on a thin insulating material, the I-type core and the coil are placed in a close distance, and excellent magnetic coupling is attained.

A manufacturing method of a transformer according to an embodiment of the present invention comprises the step of: incorporating a coil block comprising an I-type core wound around with a coil to be stacked on a first O-type core having a shape of a frame which has a window; incorporating a second O-type core having a shape of a frame and having a window to be stacked on the coil block; incorporating a first terminal block main body and a second terminal block main body which have a bisection structure to be stacked from outside on the second O-type core, placing terminal sections of the first and second terminal block main bodies on legs of the second O-type core, attaching inner ends of the pair of attachment pieces which are formed part from each other inside of each terminal section by inserting the pieces into terminal block locking grooves which are formed in the I-type core through the window of the second O-type core, and attaching the first and second terminal blocks.

According to the configuration, since the transformer is assembled by stacking up members in a direction, efficient assemblability is attained, and the method is suitable for mass production.

A transformer according to an embodiment of the present invention comprises: a first O-type core having a shape of a frame which has a window; a coil block comprising an I-type core incorporated in the first O-type core and a coil wound around the core; a second O-type core having a shape of a frame which has a window and is incorporated in the coil block; a first terminal block main body and a second terminal block main body which are placed on the second O-type core, wherein the first terminal block main body and the second terminal block main body include: terminal sections which are placed on legs of the second O-type core; and attaching pieces which protrude inside terminal sections in a direction of the I-type core and are attached to terminal block locking grooves formed in the I-type core, so that the first terminal block main body and the second terminal block main body are attached to the second O-type core.

According to the configuration, since the transformer is assembled by stacking up members in a direction, efficient assemblability is attained, and the method is suitable for mass production.

Optionally, the coil block comprises: a thin insulating material which is laid around a circumference of the I-type core; margin tapes which are laid on both ends of the insulating material, a coil which is wound between the margin tapes, wherein a terminal block locking groove is formed outside of the margin tapes around circumference of the I-type core.

According to the configuration, since the coil block is bobbinless, a bobbin is not necessary and a process to insert the I-type core into the bobbin is not also necessary. Further, since no bobbin is on a circumference of the I-type core, and a coil is placed on a thin insulating material, the I-type core and the coil are placed in a close distance, and excellent magnetic coupling is attained.

Optionally, the transformer further comprises pawl sections which are configured to engage with the first O-type core at outside of lower ends of the core attaching pieces.

Alternatively or additionally, lower ends of the core attaching pieces and the first O-type core are fixed with each other with adhesive.

In an aspect of an embodiment of the present invention, the transformer is wound with a tape on the circumference thereof.

### BRIEF DESCRIPTION OF THE DRAWINGS

FIG. 1 shows an exploded perspective view of the first embodiment of the present invention.

FIGS. 2 (a)-(c) show explanatory drawings of an assembly process of a coil block used for an embodiment of the same as above.

FIG. 3 shows a perspective view of the first embodiment of the present invention.

FIG. 4 shows a central longitudinal section of the same as above.

FIG. 5 shows an example of prevention of loosening of assembled components of the first embodiment of the present invention.

FIG. 6 shows another example of prevention of loosening of assembled components of the first embodiment of the present invention.

FIG. 7 shows an assembly perspective view of another example of prevention of loosening of assembled components of the first embodiment of the present invention.

FIG. 8 shows an exploded perspective view of a second embodiment of the present invention.

FIG. 9 shows an assembly perspective view of the same as above.

FIG. 10 shows a central longitudinal section of the same as above.

FIG. 11 shows an exploded perspective view of a third embodiment of the present invention.

FIGS. 12 (a)-(d) show explanatory drawings of an assembly process of a coil block used for embodiment of the same as above.

FIG. 13 shows an assembly perspective view of the third embodiment of the present invention.

### DESCRIPTION OF REFERENCE CHARACTERS

1,10 terminal block
1A,1B terminal block main body
1a upper surface
1b terminal section
1b′ outer surface
1c connecting section
1d output groove
1e I-type core positioning section
1f window
1g core attaching section
1g′ pawl
1h I-type core mounting section
1i second O-type core attaching section
1j protrusion
1k core attaching piece
1l output section
2 first O-type core
2b one leg
2c link leg
3 I-type core
4 coil
5, 5A coil block
5b terminal block locking groove
6 second O-type core
6a window
6b one leg
6b′ on one leg
6c link leg
7, 7A terminal
8 insulating material
9 margin tape
10 terminal block
10a terminal section
10b one surface
10c output groove
10d other surface
10e inner surface
10f attaching piece
a adhesive

### BEST MODE FOR CARRYING OUT THE INVENTION

Hereinafter, embodiments of the present invention are described with reference to the accompanying drawings.

### First Embodiment

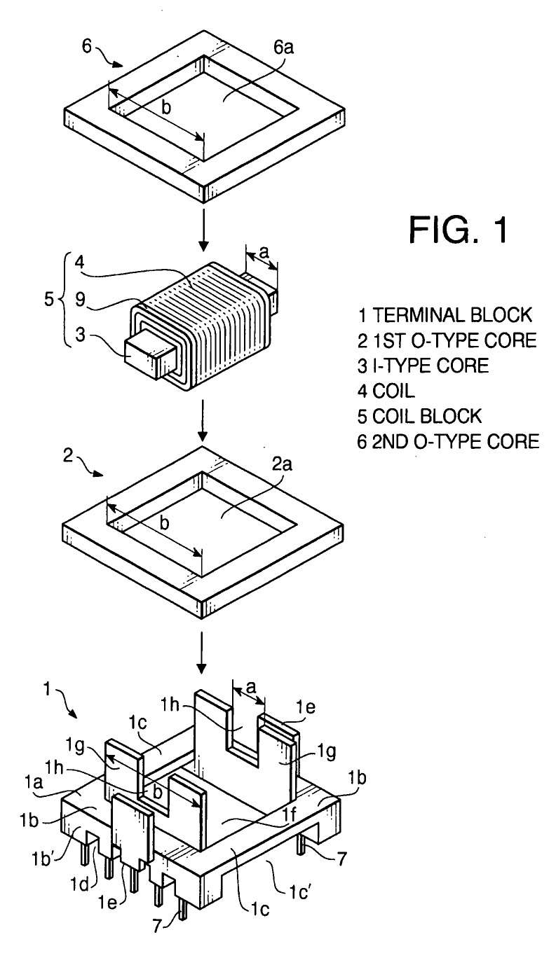

FIGS. 1-7 show exploded perspective views of small-size transformers according to embodiments of the present invention. FIG. 1 shows an exploded perspective view of the first embodiment.

The transformer according to the embodiment is configured so that the transformer can be assembled by stacking a first O-type core 2, a coil block 5 comprising an I-type core 3 and a coil 4 wound around a circumference of the core 3, and a second O-type core 6 sequentially from one direction on a terminal block 1 of a straight pin type as shown in FIG. 1.

In other words, the first O-type core 2 is placed such that the first O-type core 2 is stacked on an upper surface la of the terminal block 1. An outer form of a top plane of the terminal block 1 is configured to be a shape of a frame including a pair of terminal sections 1b which are facing to and apart from each other and have, in their inside, a rectangular window 1f in conformity with the first and second O-type cores 2 and 6, and a connecting section 1c which connects the terminal section 1b, and an upper surface 1a is flat to place the first O-type core 2 on the face. Further, terminals 7 of a straight pin type are implanted in underside of the terminal sections 1b formed at both ends, and output grooves 1d for leader lines are formed between adjacent terminals 7. Further, recessed portions 1c′ are formed underneath of connecting sections 1c.

In substantially central parts of the outer surfaces 1b′ side of each terminal sections 1b, as shown in the figure, I-type core positioning sections 1e which extend in a vertical direction upward along the outer surfaces 1b′ are formed.

Further, core attaching sections 1g, which are used to attach the I-type core 3 and to position the first O-type core 2 and the second O-type core 6, are formed on the inner surface of the side of the window 1f to extend upward. The core attaching sections 1g are formed to extend upward at inside positions of the I-type core positioning sections 1e such that the core attaching sections 1g are parallel to the I-type core positioning sections 1e.

In substantially central parts of the core attaching sections 1g, I-type core mounting sections 1h having form of vertically long notches are formed. The I-type core mounting sections 1h are rectangular, the width dimension thereof corresponds to the width dimension of the I-type core 3. Further, the core attaching sections 1g are formed over the whole internal surface of window 1f sides of terminal sections 1b. The width dimensions of the core attaching sections 1g are equal to the corresponding width dimensions b of the windows 2a and 6a of the first O-type core 2 and the second O-type core 6.

In the assembly process, the first O-type core 2 is placed from above to be stacked on the upper surface 1a of the terminal block 1 as shown with an arrow. The first O-type core 2 does not protrude outward from the terminal block 1, and increase of a floor space is prevented. At this state, since the core attaching sections 1g are placed inside the window 2a of the first O-type core 2, position shifts and looseness are prevented. Next, both ends of the I-type core 3 to which the coil is attached are set up into the I-type core mounting sections 1h of the core attaching sections 1g between the I-type core positioning sections 1e which are placed on each outer surfaces 1b of the terminal sections 1b.

The coil block 5 comprising the I-type core 3 and the coil 4 are assembled as follows.

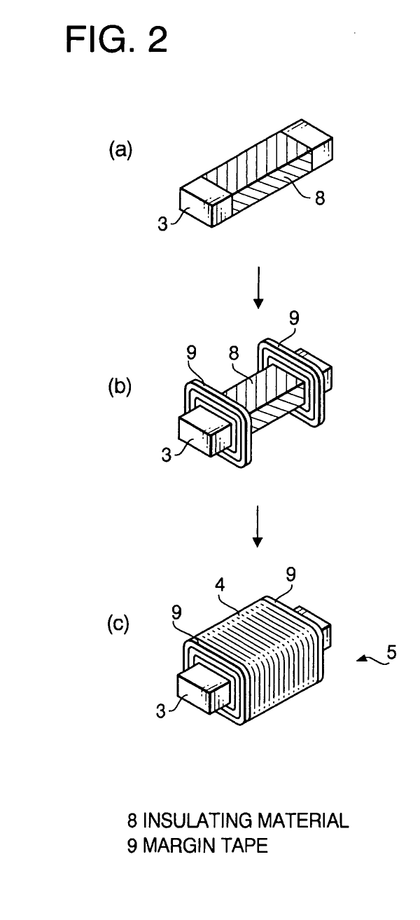

As shown in FIG. 2 (a), a thin insulating material 8 such an insulating paper or an insulating tape is wound up around an outer peripheral portion excluding both ends of the I-type core 3.

Next, as shown in FIG. 2 (b), margin tapes 9 are wound around both ends of the insulating material 8 in prescribed times in a shape of a flange.

Next, the coil block 5 is assembled by winding a coil wire between the margin tapes 9 on the both ends to make the coil 4.

As thus described, in the present invention, the coil block 5 is configured to be bobbinless by winding a coil wire around a circumference of the I-type core 3 via the insulating material 8.

Since the coil block 5 are placed between a pair of the I-type core positioning sections 1e positioned facing to and apart from each other, the I-type core positioning sections 1e prevent looseness in the axial direction. Further, a lower surface of the I-type core 3 contacts the upper surface of the first O-type core 2.

Next, the second O-type core 6 is placed to be stacked on the I-type core 3 of the coil block 5 from above, so that the second O-type core 6 contacts the I-type core 3 and makes a closed magnetic circuit. In this case, since the upper parts of the core fixing sections 1g are located inside the window 6a of the second O-type core 6, position shifts and looseness of the second O-type core 6 can be prevented.

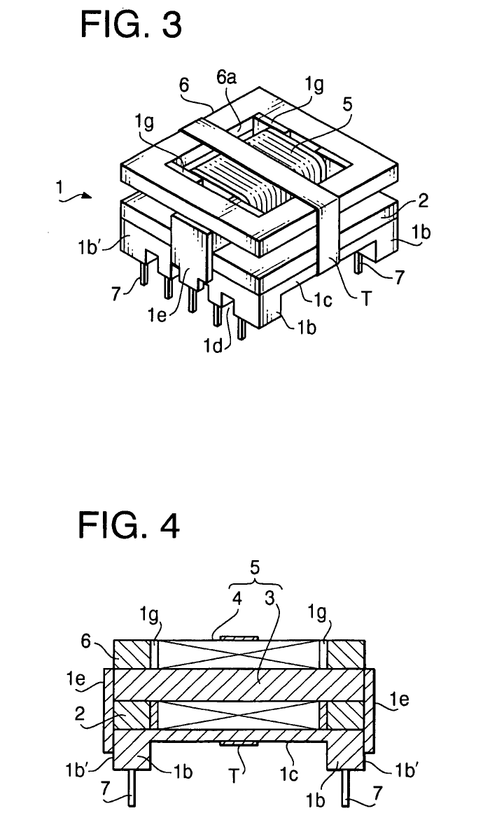

FIG. 3 and FIG. 4 show a perspective view and a central longitudinal cross section of the transformer after assembly respectively. Looseness of comportments can be prevented by winding a tape T around a circumference.

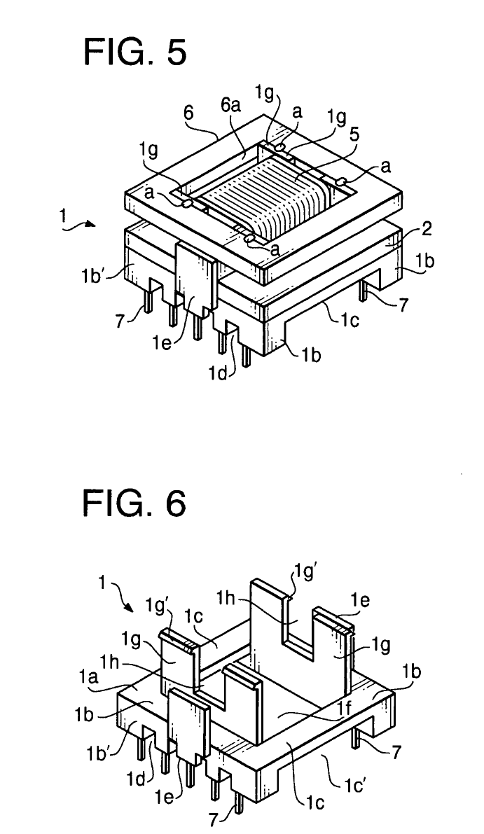

Alternately, as shown in FIG. 5, looseness in an upward direction can be prevented by applying adhesive extending from ends of the core attaching sections 1g to the second O-type core 6.

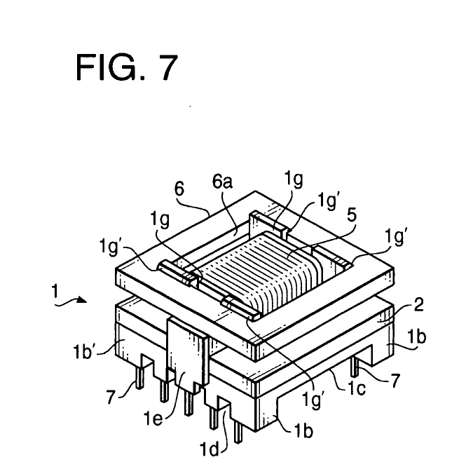

Alternatively, as shown in FIG. 6 and FIG. 7, pawls 1g′ may be made at ends of the core attaching sections 1g so that the pawls 1g′ prevent looseness in an upward direction after press-fitting of the second O-type core 6.

Further, leader lines of the coil 4 are tucked up to the terminals 7 appropriately and are connected by soldering as well known in the art, which is not particularly illustrated.

### Second Embodiment

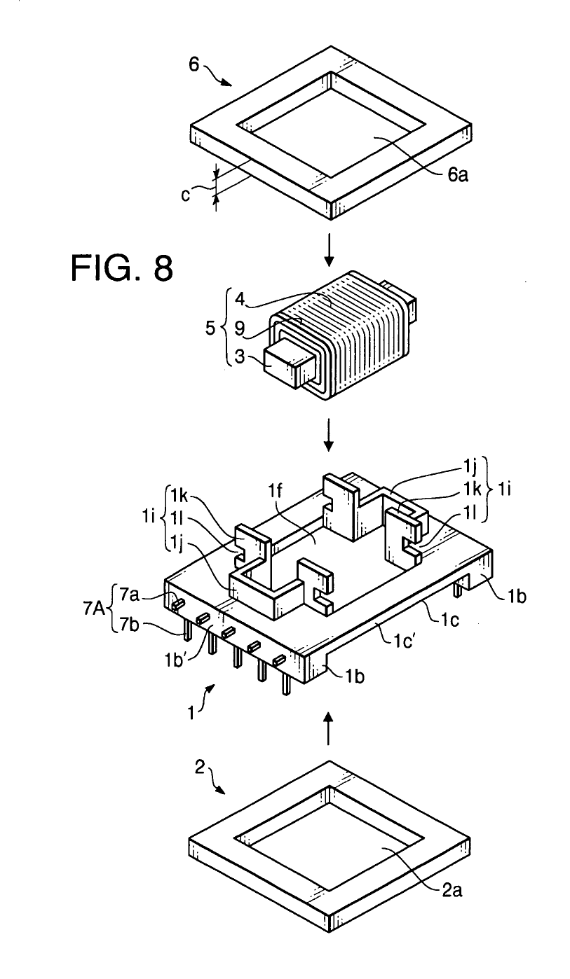

FIG. 8 shows a second embodiment according to the present invention. According to the embodiment, the transformer comprises terminals 7A of an L-pin type and is configured such that the first O-type core 2, the second O-type core 6 and the coil block 5 are stacked with respect to the terminal block 1 from above and from below. Further, assembling of the first O-type core 2 and the coil block 5, etc., is innovated to realize a low profile transformer.

That is, an appropriate number of L-type terminals 7A are implanted in the terminal sections 1b formed at both ends of the terminal block 1. Bending sections of the L-shaped terminals 7A are implanted in the terminal sections 1b and ends 7a for tucking up the leader lines protrude from the outer surfaces 1b′ of the terminal sections 1b. The other ends 7b for mounting protrude from the bottom surfaces of the terminal sections 1b′.

The first O-type attaching sections comprising recessed portions 1c′ are formed in bottoms of the connecting sections 1c connecting the terminal sections 1b at the both ends.

Shapes of the first O-type core attaching sections comprising the recessed portions 1c′ are shapes suitable to accommodate the first O-type core 2 beneath the terminal block 1.

A window 1f of which a shape is substantially the same as a shape of the coil block 5 is formed in the terminal block 1, and the coil block 5 is placed at the position. In addition, the coil block 5 is configured similarly to the above-mentioned first embodiment.

Both ends of the window 1f, that is, each side of the terminal sections 1b, have shapes corresponding to the end portions of the coil block 5. The second O-type core attaching portions 1i are placed standing in vertical direction from the upper surface of the terminal block 1.

The second O-type core attaching sections 1i is provided with protrusions 1j which protrude in the U shapes toward outer surface of the terminal sections 1b′ and accommodate, in its inside, the ends of the I-type core 3 having an almost U-shape, and core attaching pieces 1k which extend in the orthogonal direction to the projection of the protrusions 1j at the inner ends of the protrusions 1j, that is, extend toward the connecting sections 1c in a shape of a flange are formed so that the edge of the margin tape 9 of the coil 4 of the coil block 5 is situated in the inside.

The core attaching pieces 1k are formed so that upper ends of the pieces are higher than upper ends of the protrusions 1j. The difference in height is equal to thickness C of the second O-type core 6, and the second O-type core 6 is placed on the upper ends of the protrusions 1j. It is noted that at outer ends of the core attaching pieces 1k, namely, on the sides of the connecting sections 1c, output sections 11 are formed in shapes of notches to draw leader lines of the coil 4 to the terminal 7A sides.

In the assembly process, the first O-type core 2 is placed stacking up beneath the recessed portions 1c′ in the bottom of the connecting sections 1c of the terminal block 1.

Next, the coil block 5 is located in the window 1f and in the second O-type core attaching sections 1i such that the coil block 5 is stacked on the first O-type core 2 from above.

Next, the second O-type core 6 is placed to be stacked on the upper ends of the protrusions 1j from above, and on the upper surface of inner ends of the I-type core 3 located underneath are made to contact the lower surface of the second O-type core 6 to configure a closed magnetic circuit.

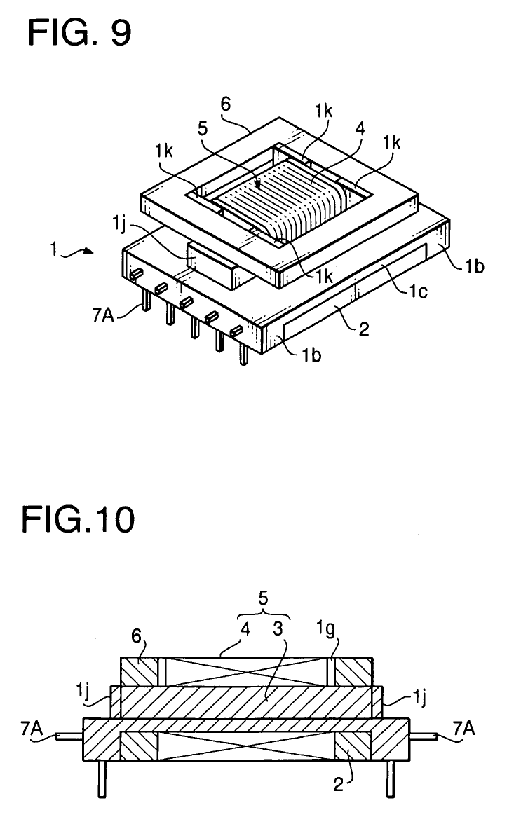

FIG. 9 shows an assembly perspective view. Leader lines of the coil 4 of the coil block 5 are drew out via through holes of the output sections 11, and tucked up to the prescribed terminals 7A.

FIG. 10 shows a central longitudinal section of FIG. 9.

Further, for prevention of loosening of components, a tape may be wound around a circumference of the assembled transformer as shown in FIGS. 3 and 4 in the first embodiment. Alternatively, as shown in FIG. 5, adhesive may be applied to be extended from ends of the core attaching pieces 1k to the second O-type core 6. Alternatively, as shown in FIG. 7, pawls may be made at ends of the core attaching pieces 1k to prevent loosening.

### Third Embodiment

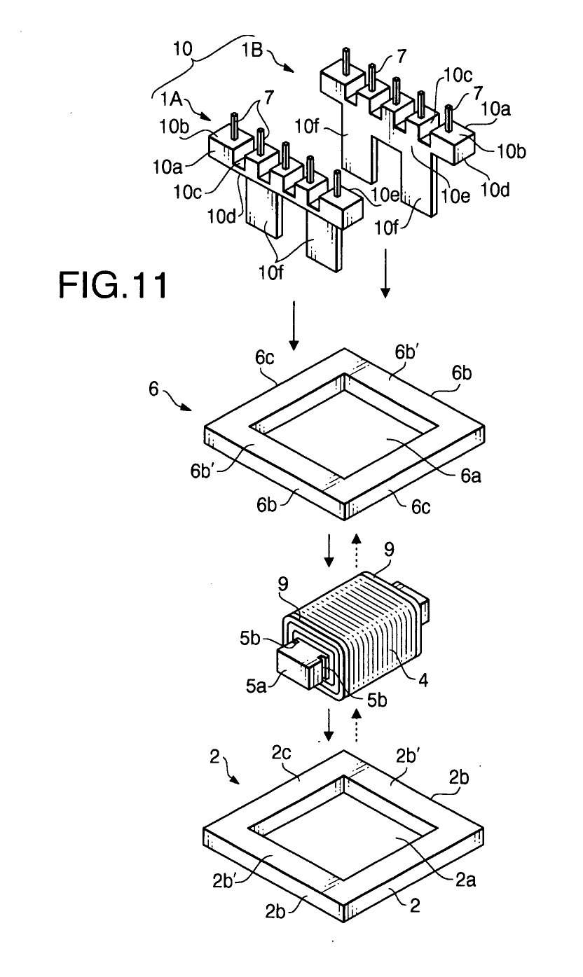

FIG. 11 shows an exploded perspective view of a third embodiment of the present invention. According to the embodiment of the present invention, the coil block 5A and the second O-type core 6 are mounted to be stacked on the first O-type core 2, and a terminal block 10 which is formed with two divided components is also mounted.

In the embodiment, as shown in FIG. 11, the first O-type core 2 and the second O-type core 6 have windows 2a, 6a similarly to the first and second embodiments.

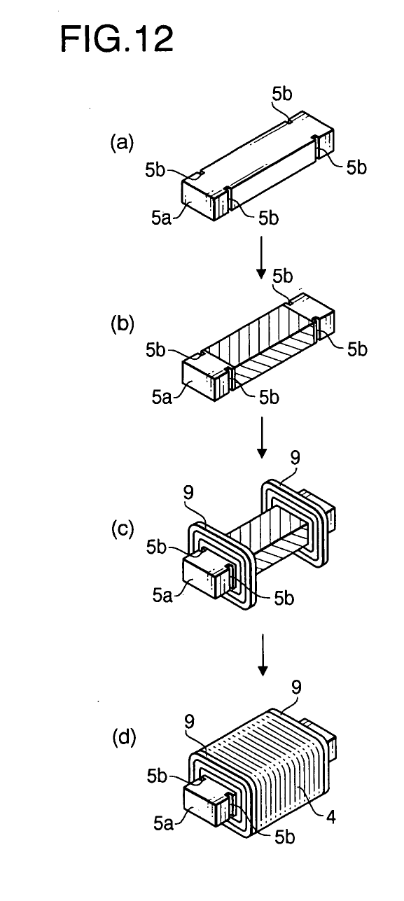

As shown in FIG. 12 (a), the coil block 5A comprises an I-type core 5a on which terminal block locking grooves 5b are formed inward from ends of the core, and a coil 4 which is wound around a circumference of the I-type core 5a between margin tapes 9. The terminal block locking grooves 5b are formed on both sides of the both ends of the I-type core 5a.

Then, as shown in FIG. 12(b), a thin insulating material 8 such as an insulating tape or an insulating paper is wound between the terminal block locking grooves 5b which are formed on both sides of the both ends of the I-type core 5a.

Next, as shown in FIG. 9(c), a margin tape 9 is wound around at ends of the insulating material 8 in shapes of flanges. The margin tape 9 is placed inside of the terminal block locking grooves 5b.

Next, as shown in FIG. 12(d), a coil wire is wound between the margin tapes which are placed apart from each other to make the coil 4, and the coil block 5A is assembled.

Further, in the embodiment, as shown in FIG. 11, the terminal block 10 is configured with the first terminal block main body 1A and the second terminal block main body 1B which are apart from each other.

The first terminal block main body 1A comprises a terminal section 10a configured with insulating resin on which appropriate number of straight type terminals 7 are implanted in the surfaces 10b. Between adjacent terminals 7, output grooves 10C are formed for drawing out leader lines. A longitudinal shape of the terminal section 10a is formed to correspond to a length and a width of one of legs 6b of the O-type core 6. The other surface 10d of the terminal section 10a is a flat surface, and is placed on one leg 6b′ of the second O-type core 6.

A pair of attaching pieces 10f which are plates extending toward the coil block 5A incorporated in the first O-type core 2 are formed on insides 10e of the terminal sections 10a, namely the window 6a side of the second O-type core 6.

Each of insides of the attaching pieces 10f is inserted into and attached to the terminal block locking grooves 5b which are formed on the both sides of the I-type core 5a in a vertical direction. Further, outer surfaces of the attaching pieces 10f contact with inner surfaces of link legs 2c, 6c which are formed at ends of legs 2b, 6b of the first O-type core 2 and the second O-type core 6 placed apart from each other and which link the legs to be fixed.

Since the second terminal block main body 1B is formed similarly to the first terminal block main body 1A, a corresponding member is indicated by the same reference number.

In the assembly process, as shown with a solid arrow line in FIG. 11, each of both ends of the I-type core 5a of the coil block 5A is placed on the central part of the upper surface 2b′ of one of legs 2b of the first O-type core 2.

Next, the second O-type core 6 is placed on both ends of the I-type core 5a to contact each other.

Next, bottom surfaces 10d of the first terminal block main body 1A and the second terminal block main body 1B are placed on one of legs 6b of the second O-type core 6 and the other leg 6b which are set apart and parallel with each other. In the case, each of insides of attaching pieces 10f of the first terminal block main body 1A and the second terminal block main body 1B are inserted into the terminal block locking grooves 5b of the I-type core 5a through the window 6a of the second O-type core 6, and attached.

In the assembly, as shown with an arrow of broken line in FIG. 11, the first O-type core 2 may be incorporated in the coil block 5A, and the assembled unit may be incorporated in the second O-type core 6, and then the first terminal block main body 1A and the second terminal block main body 1B may be incorporated in the second O-type core 6 from above.

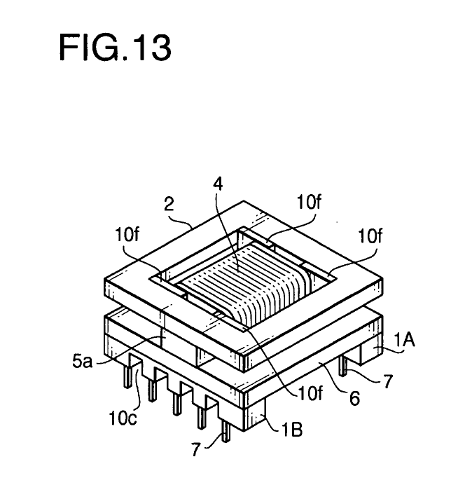

FIG. 13 shows a perspective view of an assembled transformer. To prevent loosening of members after assembly, as described in FIG. 3 and FIG. 4 in the first embodiment, a tape may be wound around the circumference. Alternatively, as described in FIG. 5, adhesive may be applied to upper portions of the attaching pieces 10f to extend to the first O-type core 2. Alternatively, as described in FIG. 7, pawls may be made at ends of the attaching pieces 10f to prevent loosening.

What is claimed is:

1. A manufacturing method of a transformer, comprising the steps of:
incorporating a first O-type core to be stacked on an upper surface of a terminal block having a shape of a frame which is implanted with terminals in bottom surfaces of terminal sections at both ends of the terminal block;
incorporating a coil block comprising an I-type core and a coil wound around the I-type core to be stacked on the first O-type core; and
incorporating a second O-type core having a shape of a frame to be stacked on the coil block.

2. A transformer, comprising:
a terminal block having a shape of a frame which is implanted with terminals in bottom surfaces of terminal sections at both ends of the terminal block;
a first O-type core of a shape of a frame which is placed on an upper surface of the terminal block;
a coil block including an I-type core of which both ends are placed on the first O-type core; and
a second O-type core having a shape of a frame which is placed on the I-type core of the coil block.

3. The transformer according to claim 2, wherein:
I-type core positioning sections having a shape of a plate are formed to stand upward at central parts of outer surfaces of both ends of terminal sections of the terminal block;
core attaching sections having a shape of a plate are formed upward on inner surfaces of the terminal sections, an I-type core is placed between the I-type core positioning sections; and
the first O-type core and the second O-type core are attached on outsides of the core attaching sections.

4. A manufacturing method of a transformer, comprising the steps of:
incorporating an first O-type core having a shape of a frame on a terminal block having a window to be formed in a shape of a frame, being implanted with terminals in bottom surfaces of terminal sections at both ends of the terminal block, and having recessed portions formed in bottoms of connecting sections which connect both ends of the terminal block so that the first O-type core is stacked on the terminal block from below;
incorporating a coil block comprising an I-type core and a coil wound around the core into the window of said terminal block from above; and
incorporating a second O-type core having a shape of a frame to be stacked on an upper surface of the coil block from above.

5. A transformer, comprising:
a terminal block having a shape of a frame which is implanted with terminals in bottom surfaces of terminal section at both ends of the terminal block;
a first O-type core which is incorporated into recessed portions formed in a bottom of the terminal block;
a coil block which has an I-type core and a coil wound around the core and is incorporated in a window of the terminal block from above; and
a second O-type core having a shape of a frame which is placed on both ends of the I-type core of the coil block.

6. The transformer according to claim 5, wherein:
a window of a shape substantially the same as an outer shape of the coil block is formed in the terminal block;
second O-type core attaching sections are formed to stand upward at both sides of the terminal sections of the window,
in the second O-type core attaching sections, substantially U-shaped protrusions which receive ends of the I-type core are formed and core attaching pieces which extend outward in a shape of a flange at inner ends of the protrusions and of which upper ends protrude upward from upper ends of the protrusions are formed; and
the second O-type core is located between the upper ends of the core attaching pieces and the upper ends of the protrusions.

7. The transformer according to claim 2,
wherein the coil block is a bobbinless coil block and comprises:
a thin insulating material laid around a circumference of the I-type core;
margin tapes laid on both ends of the insulating material; and
a coil wound between the margin tapes.

8. A manufacturing method of a transformer, comprising the steps of:
incorporating a coil block comprising an I-type core wound around with a coil to be stacked on a first O-type core having a shape of a frame which has a window;
incorporating a second O-type core having a shape of a frame and having a window to be stacked on the coil block;
incorporating a first terminal block main body and a second terminal block main body which have a bisection structure to be stacked from outside on the second O-type core,
placing terminal sections of the first and second terminal block main bodies on legs of the second O-type core,
attaching inner ends of the pair of attachment pieces which are formed apart from each other inside of each terminal section by inserting the pieces into terminal block locking grooves which are formed in the I-type core through the window of the second O-type core, and attaching the first and second terminal blocks.

9. A transformer, comprising:
a first O-type core having a shape of a frame which has a window;
a coil block comprising an I-type core incorporated in the first O-type core and a coil wound around the core;
a second O-type core having a shape of a frame which has a window and is incorporated in the coil block; and
a first terminal block main body and a second terminal block main body which are placed on the second O-type core,
wherein the first terminal block main body and the second terminal block main body include:
terminal sections which are placed on legs of said second O-type core; and
attaching pieces which protrude inside terminal sections in a direction of said I-type core and are attached to terminal block locking grooves formed in the I-type core, so that the first terminal block main body and the second terminal block main body are attached to said second O-type core.

10. The transformer according to claim 9,
wherein the coil block comprises:
a thin insulating material which is wound around a circumference of the I-type core;
margin tapes which are placed at both ends of the insulating material; and
a coil which is wound between the margin tapes,
wherein a terminal block locking groove is formed outside of the margin tapes around circumference of said I-type core.

11. The transformer according to claim 5,
wherein the coil block is a bobbinless coil block comprising:
a thin insulating material which is laid around a circumference of the I-type core;
margin tapes which are laid on both ends of the insulating material; and
a coil which is wound between the margin tapes.

12. The transformer according to claim 3, further comprising pawl sections which are configured to engage with the second O-type core at outside of upper ends of the core attaching sections.

13. The transformer according to claim 6, further comprising pawl sections which are configured to engage with the second O-type core at outside of upper ends of the core attaching pieces.

14. The transformer according to claim 9, further comprising pawl sections which are configured to engage with the first O-type core at outside of lower ends of the core attaching pieces.

15. The transformer according to claim 3,
wherein upper ends of the core attaching sections and the second O-type core are fixed with each other with adhesive.

16. The transformer according to claim 6,
wherein upper ends of the core attaching pieces and the second O-type core are fixed with each other with adhesive.

17. The transformer according to claim 9,
wherein lower ends of the core attaching pieces and the first O-type core are fixed with each other with adhesive.

18. The transformer according to claim 2,
wherein a tape is wound around a circumference thereof.

19. The transformer according to claim 5,
wherein a tape is wound around a circumference thereof.

20. The transformer according to claim 9,
wherein a tape is wound around a circumference thereof.
